(19) United States
(12) Patent Application Publication
(10) Pub. No.: US 2012/0058751 A1
(43) Pub. Date: Mar. 8, 2012

(54) SYSTEM AND METHOD FOR GENERATING A DIG TICKET REQUEST

(75) Inventor: Matthew D. Colley, Franklin, IN (US)

(73) Assignee: UNDERGROUND SAFETY ALLIANCE, Greenwood, IN (US)

(21) Appl. No.: 12/876,873

(22) Filed: Sep. 7, 2010

(51) Int. Cl. H04M 3/493

(52) U.S. Cl. 455/414.2

(57) ABSTRACT

A system, device, and method for generating a dig ticket for a proposed dig site using a mobile communication device includes obtaining location data indicative of the current location of the mobile computing device and displaying a digital map on the display of the mobile computing device that includes indicia of the proposed dig site, which corresponds to the location of the mobile computing device. If the location of the proposed dig site is correct, a dig ticket may be generated and transmitted to a dig site authorization server over a network.

### TECHNICAL FIELD

The present disclosure relates generally to the generation and submission of dig tickets for proposed dig sites and, more particularly, to system and methods for remotely generating dig tickets.

### BACKGROUND

Utility companies, such as electric, gas, water, and communication companies, own and maintain underground utilities. Such underground utilities include, for example, gas pipes, water conduits, electrical and communication wires, and the like. To provide utility service to end consumers, the underground utilities may cross public and private properties. However, because the utilities are disposed underground, the property owner and/or excavator planning to dig on the property may be unaware of the presence of the underground utility based on a simple visual inspection of the property. Excavating without knowledge of the location of underground utilities can result in severe damage to the underground utility and poses significant danger to the excavator, land owner, utility company, and surrounding community.

Many cities and other jurisdictions require homeowners and other excavators to notify the utility company, or intermediary company, prior to the initiation of any excavation. Once notified, the utility companies identify and mark the underground utilities in the vicinity of the planned excavation so that the underground utility lines may be avoided. The request to have the proposed dig site marked for underground utilities is commonly known as a “dig ticket.” Typically, a dig ticket for a proposed dig site is generated by the homeowner or excavation company calling the utility companies, or an intermediary company that handles dig ticket requests, to notify the companies that digging in the vicinity will occur and request the marking of the underground utility lines. Depending on the particular location of the proposed dig site, accurate identification of the location may be difficult, which may increase the difficulty of generating a dig ticket for the proposed dig site.

### SUMMARY

According to one aspect, a mobile computing device may include a display, a processor, and a memory device. The memory device may have stored therein a plurality of instructions, which when executed by the processor, cause the mobile computing device to obtain location data indicative of the current location of the mobile computing device and display a digital map on the display of the mobile computing device. The digital map may include indicia of a proposed dig site corresponding to the location of the mobile computing device. The plurality of instructions may also cause the processor to transmit a dig ticket request to a dig site authorization server over a network in response the dig site being verified by a user of the mobile computing device.

In some embodiments, the mobile computing device may further include a global positioning system (GPS) circuit. In such embodiments, the plurality of instructions may further cause the processor to obtain location data comprises to determine the GPS coordinates of the mobile computing device using the GPS circuit. Additionally, the plurality of instructions may cause the processor to determine the location of the proposed dig site based on the GPS coordinates. In some embodiments, the mobile computing device may obtain the location data by receiving location data indicative of the current location of the mobile computing device from a remote server. Such location data may be determined based on an Internet Protocol (IP) address of the mobile computing device. Alternatively or additionally, the mobile computing device may obtain the location data may be determined using a cellular triangulation procedure.

In some embodiments, the digital map is a second digital map and obtaining location data may include to display a first digital map on the display to the user, receive a selection of an area of the first digital map provided by the user, and determine location data indicative of the location of the selected area of the first digital map. Additionally, in some embodiments, to determine location data indicative of the location of the selected area may include to determine longitude and latitude coordinates of the selected area. Further, in some embodiments, to display the second digital map may include to display a second digital map including indicia of the proposed dig site corresponding to the determined longitude and latitude coordinates.

Additionally, in some embodiments, the plurality of instructions may cause the processor to receive a street address provided by the user and determine the location data based on the street address. The plurality of instructions may also further cause the processor to determine additional dig parameter data that identifies parameters of the digging activity to be performed at the dig site. In some embodiments, the additional dig parameter data may include at least one of: type of digging activity, depth of proposed digging activity, and duration of digging activity. Additionally, in some embodiments, the plurality of instructions may further cause the processor to determine longitude and latitude coordinates of the dig site based on the location data. The plurality of instructions may yet further cause the processor to receive a communication from dig site authorization server confirming the dig site location in some embodiments.

According to another aspect, a method for generating a dig ticket may include determining a current location of a mobile computing device based on global positioning system (GPS) coordinate data generated by a GPS circuit of the mobile computing device and displaying a digital map on the mobile computing device. The digital map may include indicia of a proposed dig site corresponding to the location of the mobile computing device. The method may also include verifying the proposed dig site based on a response by a user of the mobile computing device and transmitting a dig ticket request to a dig site authorization server over a network in response the dig site being verified.

In some embodiments, the method may further include receiving additional dig parameter data from the user, the dig parameter data identifying parameters of the digging activity to be performed at the dig site. The additional dig parameter data may include at least one of: type of digging activity, depth of proposed digging activity, and duration of digging activity. The method may also include determining the longitude and latitude coordinates of the dig site based on the GPS coordinate data. Additionally, in some embodiments, the method may include receiving an e-mail communication from dig site authorization server that confirms the dig site location.

According to yet a further aspect, a tangible, machine readable medium may include a plurality of instructions, that in response to being executed, result in a mobile computing device determining a current location of the mobile computing device and displaying a digital map on the mobile computing device. The digital map may include indicia of a proposed dig site corresponding to the location of the mobile computing device. The execution of the plurality of instructions may further result in the mobile computing device verifying the proposed dig site based on a response by a user of the mobile computing device, generating a dig ticket request that identifies the proposed dig site in response to the dig site being verified, and transmitting the dig ticket request to a dig site authorization server over a network.

In some embodiments, determining the current location of the mobile computing device may include determining the current location based on global positioning system (GPS) coordinate data generated by a GPS circuit of the mobile computing device. Additionally or alternatively, determining the current location of the mobile computing device may include determining the current location based on a street address supplied by the user.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of one embodiment of a system for generating a dig ticket request;

FIG. 2 is a simplified flowchart of one embodiment of a method for generating a dig ticket request using a mobile computing device of the system of FIG. 1;

FIG. 3 is a simplified flowchart of one embodiment of a method of obtaining additional dig parameters from the user of the mobile computing device of the system of FIG. 1;

FIG. 4 is a simplified flowchart of one embodiment of a method for obtaining the location of a dig site from a user of the mobile computing device of the system of FIG. 1; and

FIG. 5 is an illustrative screen display that may be displayed on the mobile computing device of the system of FIG. 1 the execution of the methods of FIG. 2, 3, and/or 4.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure may be implemented in hardware, firmware, microcode, Central Processing Unit (CPU) instructions, software, or any combination thereof. Embodiments of the disclosure implemented in a computer system may include one or more bus-based interconnects between components and/or one or more point-to-point interconnects between components. Embodiments of the invention may also be implemented as instructions stored on a machine-readable, tangible medium, which may be read and executed by one or more processors. A machine-readable, tangible medium may include any tangible mechanism for storing or transmitting information in a form readable by a machine (e.g., a computing device). For example, a machine-readable, tangible medium may include read only memory (ROM); random access memory (RAM); magnetic disk storage media; optical storage media; flash memory devices; and other tangible mediums.

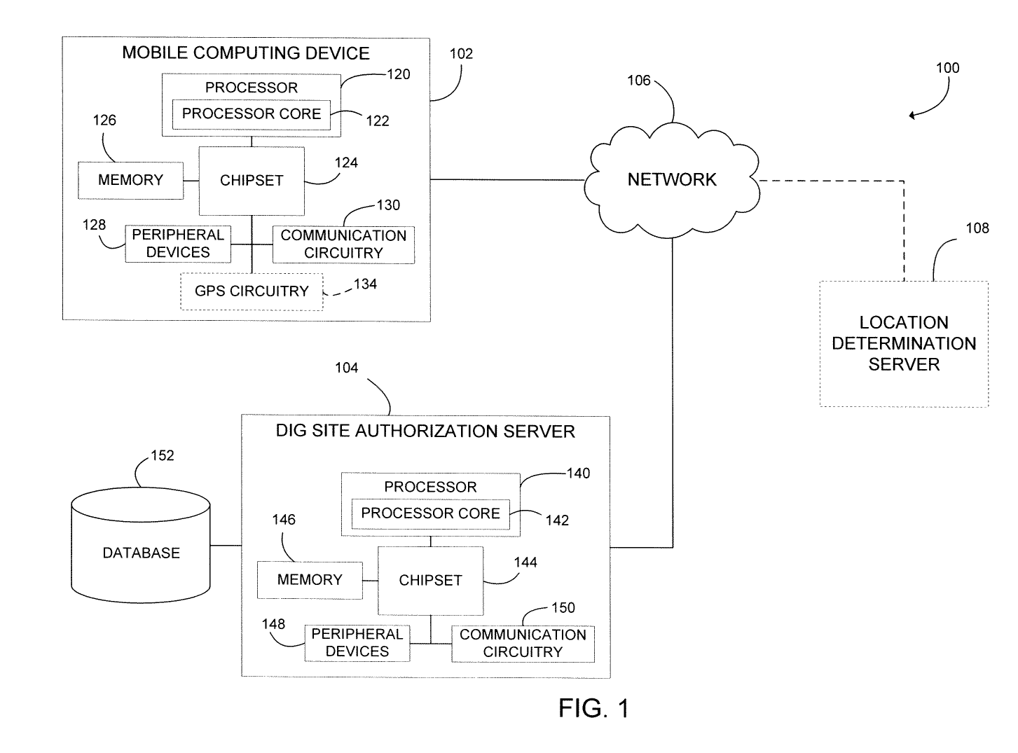

Referring now to FIG. 1, a system 100 for generating a dig ticket includes a mobile computing device 102, a dig site authorization server 104, and a network 106. In use, as discussed in more detail below, a user of the mobile computing device 102 may remotely generate a dig ticket using the mobile computing device 102 and transmit the dig ticket to the dig site authorization server 104. The dig ticket identifies a proposed location of a dig site and requests marking of underground utilities if required. The dig ticket may include additional dig site parameters in addition to the location of the proposed dig site such as the type of digging activity, the depth of the proposed digging activity, and the duration of the digging activity. In one embodiment, the location of the dig site is determined based on the location of the mobile computing device 102. For example, the GPS coordinates of the location of the mobile computing device 102 may be used. Additionally or alternatively, the location of the mobile computing device 102 may be determined using a cellular triangulation procedure. In embodiments wherein the location of the mobile computing device 102 cannot be determined, the user may supply information to the mobile computing device 102 from which the location of the proposed dig site may be determined, such as a street address.

After the location of the proposed dig site is determined, a digital map of the proposed dig site is displayed to the user for verification of the dig site. If the dig site is verified, a dig ticket request may be generated on the mobile computing device 102 and transmitted to the dig site authorization server 104 over the network 106. The server 104 may perform one or more actions in response to receiving the dig ticket request from the mobile computing device 102 such as storing store the dig ticket request, generating a formal dig ticket, contacting a utility or marking company, and/or sending a confirmation communication, such as an e-mail, to the mobile computing device 102. In this way, a user of the mobile computing device 102 may generate dig tickets in an automated or semi-automated manner.

Although only one mobile computing device 102, one dig site authorization server 104, and one network 106 are illustratively shown in FIG. 1, the system 100 may include any number of mobile computing devices 102, dig site authorization servers 104, and networks 106 of similar or dissimilar architecture. For example, the mobile computing device 102 may be configured to communicate with multiple dig site authorization server 104 to generate remotely one or more dig tickets.

The mobile computing device 102 may be embodied as any type of mobile computing device capable of performing the functions described herein. For example, the mobile computing device 102 may be embodied as a cellular phone, a smart phone, a mobile interne device, a handheld computer, a laptop computer, a personal digital assistant, a telephony device, or other portable computing device. In the illustrative embodiment of FIG. 1, the mobile computing device 102 includes a processor 120, a chipset 124, a memory 126, one or more peripheral devices 128, and communication circuitry 130. In some embodiments, several of the foregoing components may be incorporated on a motherboard of the mobile computing device 102, while other components may be communicatively coupled to the motherboard via, for example, a peripheral port. Furthermore, it should be appreciated that the mobile computing device 102 may include other components, sub-components, and devices commonly found in a computer and/or computing device, which are not illustrated in FIG. 1 for clarity of the description.

The processor 120 of the mobile computing device 102 may be embodied as any type of processor capable of executing software/firmware, such as a microprocessor, digital signal processor, microcontroller, or the like. The processor 120 is illustratively embodied as a single core processor having a processor core 122. However, in other embodiments, the processor 120 may be embodied as a multi-core processor having multiple processor cores 122. Additionally, the mobile computing device 102 may include additional processors 120 having one or more processor cores 122.

The chipset 124 of the mobile computing device 102 may include a memory controller hub (MCH or “northbridge”), an input/output controller hub (ICH or “southbridge”), and a firmware device. The firmware device of the chipset 124 may be embodied as a memory device for storing Basic Input/Output System (BIOS) data and/or instructions and/or other information (e.g., a BIOS driver used during booting of the mobile computing device 102). However, in other embodiments, chipsets having other configurations may be used.

The processor 120 is communicatively coupled to the chipset 124 via a number of signal paths. These signal paths (and other signal paths illustrated in FIG. 1) may be embodied as any type of signal paths capable of facilitating communication between the components of the mobile computing device 102. For example, the signal paths may be embodied as any number of wires, cables, light guides, printed circuit board traces, via, bus, intervening devices, and/or the like.

The memory 126 of the mobile computing device 102 may be embodied as one or more memory devices or data storage locations including, for example, dynamic random access memory devices (DRAM), synchronous dynamic random access memory devices (SDRAM), double-data rate synchronous dynamic random access memory device (DDR SDRAM), flash memory devices, and/or other volatile memory devices. The memory 126 is communicatively coupled to the chipset 124 via a number of signal paths. Although only a single memory device 126 is illustrated in FIG. 1, in other embodiments, the mobile computing device 102 may include additional memory devices. Various data and software may be stored in the memory device 126. For example, one or more operating systems, applications, programs, libraries, and drivers that make up the software stack executed by the processor 120 may reside in memory 126 during execution. Furthermore, software and data stored in memory 126 may be swapped between the memory 126 and a data storage device of the peripheral devices 128 as part of memory management operations.

The peripheral devices 128 of the mobile computing device 102 may include any number of peripheral or interface devices. For example, the peripheral devices 128 may include a display, a keyboard, a mouse, one or more data storage devices such as an internal or external hard drive, and/or other peripheral devices. The particular devices included in the peripheral devices 128 may depend upon, for example, the intended use of the mobile computing device 102. The peripheral devices 128 are communicatively coupled to the chipset 124 via a number of signal paths thereby allowing the chipset 124 and/or processor 120 to receive inputs from and send outputs to the peripheral devices 128.

The communication circuitry 130 of the mobile computing device 102 may be embodied as any number of devices and circuitry for enabling communications between the mobile computing device 102 and the dig site authorization server 104 over the network 106. The communication circuitry 130 is communicatively coupled to the chipset 124 via a number of signal paths. The communication circuitry 130 may include one or more wired and/or wireless network interfaces to facilitate communications over the wired and/or wireless portions of the network 110.

The network 106 may be embodied as any number of various wired and/or wireless telecommunication networks. For example, the network 106 may be embodied as or otherwise include one or more cellular networks, telephone networks, local or wide area networks publicly available global networks (e.g., the Internet), or any combination thereof. Furthermore, the network 106 may include any number of additional devices to facilitate communication between the mobile computing device 102 and the dig site authorization server 104 such as routers, switches, intervening computers, and/or the like. The mobile computing device 102 and the dig site authorization server 104 may use any suitable communication protocol to communicate with each other over the network 106 depending on, for example, the particular type of network(s) 106.

In some embodiments, the mobile computing device 102 may also include Global Positioning System (GPS) circuitry 134. In such embodiments, the GPS circuitry 134 is configured to generate coordinate data indicative of the location of the mobile computing device 102. As discussed in more detail below, the coordinate data may be used to determine the location of the proposed dig site and, in some embodiments, transmitted to the dig site authorization server 104 as part of the dig ticket request.

The dig site authorization server 104 may be embodied as any type of computer server or other computing device capable of performing the functions described herein. In the illustrative embodiment of FIG. 1, the dig site authorization server 104 includes a processor 140, a chipset 144, a memory 146, one or more peripheral devices 148, and communication circuitry 150. In some embodiments, several of the foregoing components may be incorporated on a motherboard of the dig site authorization server 104, while other components may be communicatively coupled to the motherboard via, for example, a peripheral port. Furthermore, it should be appreciated that the dig site authorization server 104 may include other components, sub-components, and devices commonly found in a computer server, which are not illustrated in FIG. 1 for clarity of the description.

The processor 140 of the dig site authorization server 104 may be embodied as any type of processor capable of executing software/firmware, such as a microprocessor, digital signal processor, microcontroller, or the like. The processor 140 is illustratively embodied as a single core processor having a processor core 142. However, in other embodiments, the processor 140 may be embodied as a multi-core processor having multiple processor cores 142. Additionally, the dig site authorization server 104 may include additional processors 120 having one or more processor cores 122.

The chipset 144 of the dig site authorization server 104 may include a memory controller hub (MCH or “northbridge”), an input/output controller hub (ICH or “southbridge”), and a firmware device. The firmware device of the chipset 144 may be embodied as a memory device for storing Basic Input/Output System (BIOS) data and/or instructions and/or other information (e.g., a BIOS driver used during booting of the dig site authorization server 104). However, in other embodiments, chipsets having other configurations may be used.

The processor 140 is communicatively coupled to the chipset 144 via a number of signal paths. Similar to the signal paths of the mobile computing device 102, the signal paths of the dig site authorization server 104 may be embodied as any type of signal paths capable of facilitating communication between the components of the dig site authorization server 104. For example, the signal paths may be embodied as any number of wires, cables, light guides, printed circuit board traces, via, bus, intervening devices, and/or the like.

The memory 146 of the dig site authorization server 104 may be embodied as one or more memory devices or data storage locations including, for example, dynamic random access memory devices (DRAM), synchronous dynamic random access memory devices (SDRAM), double-data rate synchronous dynamic random access memory device (DDR SDRAM), flash memory devices, and/or other volatile memory devices. The memory 146 is communicatively coupled to the chipset 144 via a number of signal paths. Although only a single memory device 146 is illustrated in FIG. 1, in other embodiments, the dig site authorization server 104 may include additional memory devices. Various data and software may be stored in the memory device 146. For example, one or more operating systems, applications, programs, libraries, and drivers that make up the software stack executed by the processor 140 may reside in memory 146 during execution. Furthermore, software and data stored in memory 146 may be swapped between the memory 146 and a data storage device of the peripheral devices 148 as part of memory management operations.

The peripheral devices 148 of the dig site authorization server 104 may include any number of peripheral or interface devices. For example, the peripheral devices 148 may include a display, a keyboard, a mouse, one or more data storage devices such as an internal or external hard drive, and/or other peripheral devices. The peripheral devices 148 are communicatively coupled to the chipset 144 via a number of signal paths thereby allowing the chipset 144 and/or processor 140 to receive inputs from and send outputs to the peripheral devices 148.

The communication circuitry 150 of the dig site authorization server 104 may be embodied as any number of devices and circuitry for enabling communications between the dig site authorization server 104 and the mobile computing device 102 over the network 106. The communication circuitry 130 is communicatively coupled to the chipset 154 via a number of signal paths. The communication circuitry 150 may include one or more wired and/or wireless network interfaces to facilitate communications over the wired and/or wireless portions of the network 106.

The dig site authorization server 104 may also include a database 152. The database 152 may be embodied as software and/or hardware and may form a separate component from the server 104 or may be incorporated therein. The dig site authorization server 104 may store data, such as dig tickets and other information, in the database 152. Such data may be stored in any database format such as a relational database, an object oriented database, a sequential flat file, or the like.

In some embodiments, the system 100 may also include a location determination server 108. The location determination server 108 may be communicated with by the dig site authorization server 104 and/or the mobile computing device 102 over the network 106 to determine location data indicative of the location of the mobile computing device 102. For example, in embodiments wherein the mobile computing device 102 does not include the GPS circuitry 134, the location of the mobile computing device 102 may be determined via a cellular triangulation procedure performed by the location determination server 108 or otherwise derived based on information obtained from the location determination server 108. In other embodiments, the location determination server 108 may use other methodology to determine the location data indicative of the location of the mobile computing device 102.

In use, a user of the mobile communication device 102 may remotely generate a dig ticket using the device 102. To do so, the mobile communication device 102 may execute a method 200 to generate a dig ticket. The method 200 begins with block 202 in which the initialization procedures are performed. For example, software applications may be loaded, communication with the dig site authorization server 104 may be established, and other initialization procedures may be performed in block 202. Subsequently, in block 204, user identification data is obtained. Such identification data may include the mobile telephone number of the mobile communication device 102, the name of the user of the device 102, an e-mail address or other communication address of the user, an Internet Protocol (IP) address of the mobile computing device, and/or other data usable to identify the user and/or the mobile computing device 102.

In block 206, the mobile computing device 102 determines whether the user desires to generate a dig ticket request. The user may prompt the mobile computing device 102 to do so by, for example, selecting on an icon or otherwise supplying an input to the mobile computing device 102. If the user desires to generate a dig ticket request, the method 200 advances to block 208 in which mobile computing device 102 determines whether the user is at the location of the proposed dig site. To do so, the user may be presented with a prompt on the display of the mobile computing device 102 that requests confirmation that the user is at the proposed dig site.

If the user is determined to be at the location of the proposed dig site, the method 200 advances to block 210 in which location data indicative of the current location of the mobile computing device 102 is determined. In embodiments in which the mobile computing device 102 includes the GPS circuitry 134, the location data may be embodied as the GPS coordinates of the mobile computing device 102, which may be determined in block 212. Alternatively, the mobile computing device 102 (or the dig site authorization server 104) may communicate with location determination server 108 to determine the location data indicative of the location of the mobile computing device 102. For example, in one embodiment, location determination server 108 is configured to determine coordinate data of the location of the mobile computing device 102 by performing a cellular triangulation procedure on the mobile computing device 102. The location determination server 108 may transmit the determined location data to the mobile computing device 102. In embodiments in which the dig site authorization server 104 communicates with the location determination server 108, the server 104 may or may not transmit the location data indicative of the location of the mobile computing device 102 received from the location determination server 108 to the device 102.

In block 210, the mobile computing device 102 (or the dig site authorization server 104) determines the longitude and latitude coordinates of the location of the proposed dig site based on the location data. That is, because the mobile computing device 102 is at the location of the proposed dig site, the location of the mobile computing device 102 correlates to the location of the proposed dig site. As such, the longitude and latitude coordinates of the location of the mobile computing device 102 is used as coordinates of the proposed dig site. Depending on the format of the location data, the mobile computing device 102 (or the dig site authorization server 104) may convert the location data to longitude and latitude coordinates. To do so, the mobile computing device 102 may communicate with other remote servers to perform a cross-referencing or geocodeing procedure.

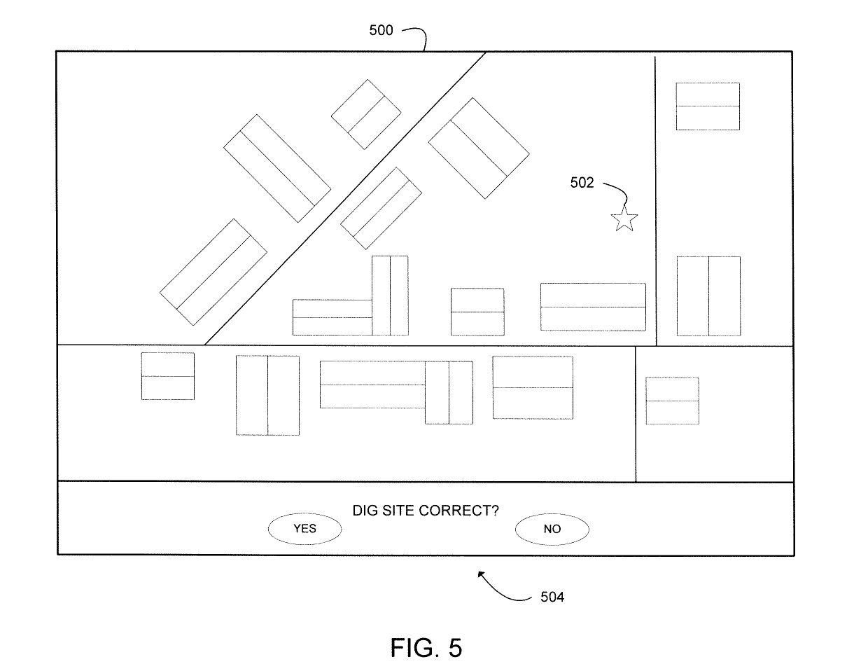

After the longitude and latitude coordinates of the dig site have been determined in block 214, a digital map of the determined dig site location is displayed to the user on the display of the mobile computing device 102. One embodiment of an illustrative digital map 500 is illustrated in FIG. 5. The digital map 500 may have any suitable resolution and includes indicia 502 of the location of the proposed dig site. The indicia 502 may be embodied as any type of indicia capable of indicating to the user the location of the proposed dig site on the digital map 500. The user may review the location of the proposed dig site to determine whether the determined dig site location is correct. For example, the user may provide an indication of whether the determined dig site location is correct by selecting an appropriate icon from a menu 504.

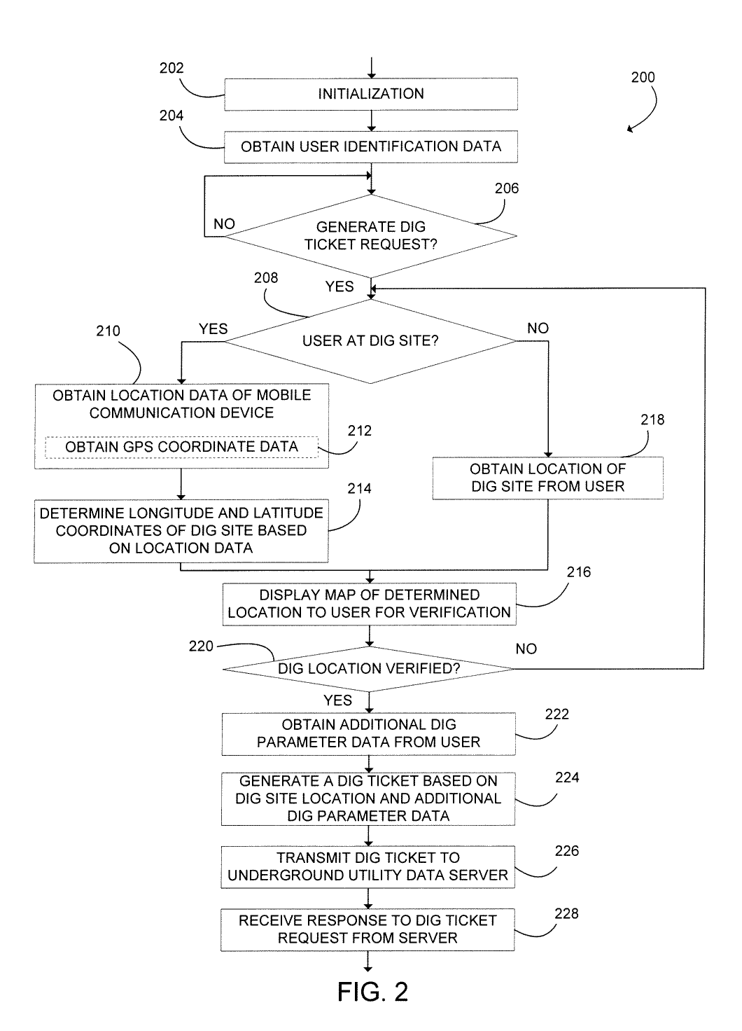

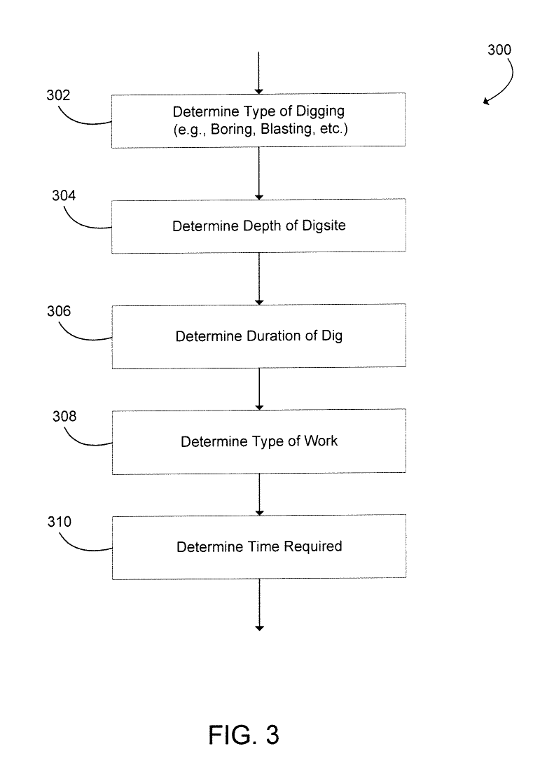

Referring back to FIG. 2, if the user determines that the determined dig location is incorrect in block 220, the method 200 loops back to block 208 wherein the location of the dig site may be determined again. However, if the user determines that the determined location of the dig site is correct, the method 200 advances to 222 in which additional dig parameter data is obtained from the user. To do so, the user may be prompted with various questions related to aspects of the proposed digging activity and/or may directly supply the additional parameter data. For example, as illustrated in FIG. 3, the mobile computing device 102 may execute a method 300 for obtaining additional dig parameter data. The method 300 begins with block 302 in which the user is prompted to supply or otherwise select the type of digging to be done at the proposed dig site. Any number of individual questions or prompts may be supplied to the user in block 302 to determine the type of digging to be done such boring, blasting, etc.). In block 304, the user is prompted to provide the proposed depth of the dig site. Additionally, in block 306, the user is prompted to provide the proposed duration of the dig (i.e., how long with the digging activity take). Additional dig parameters including the type of work to be done and the time required may be provided by the user in block 308 and block 310. In addition, other or additional dig parameter data may be obtained in the method 300 to further identify various aspects of the proposed digging activity.

Referring back to FIG. 2, after the additional dig parameter data is obtained in block 222, the mobile computing device 102 generates a dig ticket request in block 224. The dig ticket request is based on the determined location of the dig site and any additional dig parameters provided by the user. That is, the dig ticket request identifies the location of the proposed dig site and may include additional data regarding the proposed digging activity. Additionally, in some embodiments, the dig ticket request also includes the identification data, or a portion thereof, of the user as determined in block 204. For example, the dig ticket request may include the user's name, address, and e-mail address.

In block 226, the mobile computing device 102 transmits the dig ticket request to the dig site authorization server 104 over the network 106. The dig site authorization server 104 may store the dig ticket request in the database 152 and perform one or more actions in response to receiving the dig ticket request. For example, in block 228, the dig site authorization server 104 may send a confirmation communication to the mobile computing device 102 that confirms receipt of the dig ticket request. The user of the mobile computing device 102 may review the confirmation communication to ensure all the data contained therein is accurate and complete. Additionally, the dig site authorization server 104 may generate a formal dig ticket, contact a utility or marking company, and/or perform other actions based on the dig ticket request received from the mobile computing device 102.

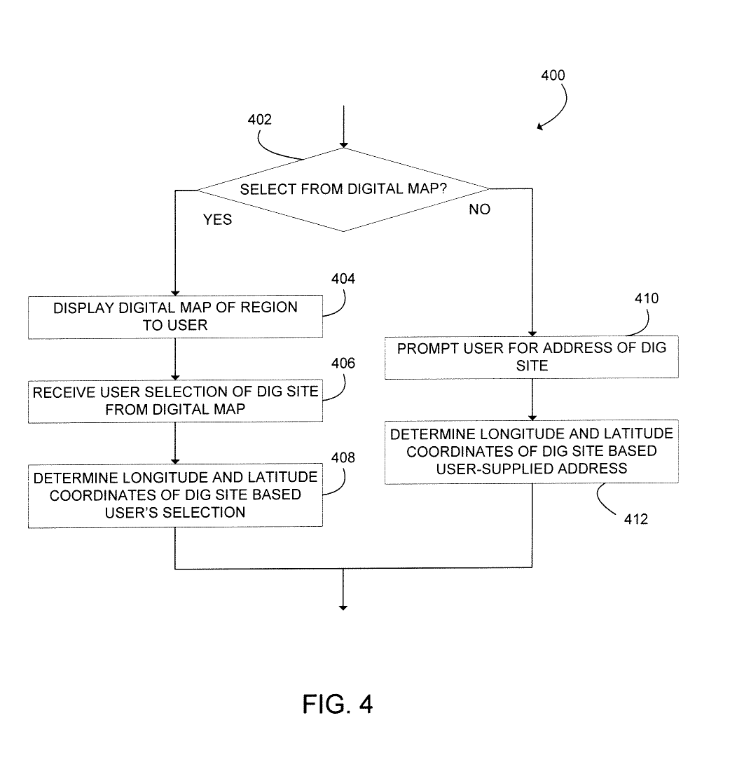

Referring now back to block 208, if the mobile computing device 102 determines that the user is not at the proposed dig site, the method 200 advances to block 218 in which the location of the proposed dig site is manually obtained from the user. To do so, the mobile computing device 102 may execute a method 400, illustrated in FIG. 4, for obtaining the location of the proposed dig site from the user. The method 400 begins with block 402 in which the mobile computing device 102 determines whether the user wants to select the proposed dig site from a digital map. If so, the method 400 advances to block 404. In block 404, a digital map is displayed to the user on the mobile computing device 102. The area initially displayed in the digital map may be based on the identification data determined in block 204 of the method 200 (e.g., the home city of the user) or may be a map of a larger area such as a state, country, or region. The user may zoom in or out of the digital map, scroll across the map, and otherwise interact with the digital map to find the location of the proposed dig site.

After the user has found the location of the proposed dig site, the user may select the location on the digital map in block 406. In response, the mobile computing device 102 determines the longitude and latitude coordinates of the location of the proposed dig site based on the user's selection. To do so, in some embodiments, the mobile computing device 102 may communicate with other remote servers to geocode or otherwise determine the longitude and latitude coordinates of the proposed dig site.

Referring back to block 402, if mobile computing device 102 determines that the user does not want to select the proposed dig site from a digital map, the method 400 advances to block 410 in which the user may supply the street address of the dig site. Subsequently, in block 412, the mobile computing device 102 determines the longitude and latitude coordinates of the location of the proposed dig site based on the street address provided by the user. To do so, in some embodiments, the mobile computing device 102 may communicate with other remote servers to geocode or otherwise determine the longitude and latitude coordinates of the proposed dig site. It should be appreciated that the user is able to verify the location of the proposed dig site is accurate by reviewing the digital map displayed to the user on the mobile computing device 102 in block 216. In this way, the user of the mobile computing device 102 may remotely generate dig tickets in an automated, semi-automated, or manual manner.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

1. A mobile computing device comprising:
a display;
a processor; and
a memory device having stored therein a plurality of instructions, which when executed by the processor, cause the mobile computing device to:
obtain location data indicative of the current location of the mobile computing device;
display a digital map on the display of the mobile computing device, the digital map including indicia of a proposed dig site corresponding to the location of the mobile computing device; and
transmit a dig ticket request to a dig site authorization server over a network in response the dig site being verified by a user of the mobile computing device.

2. The mobile computing device of claim 1, wherein the mobile computing device further comprises a global positioning system (GPS) circuit, and
wherein to obtain location data comprises to determine the GPS coordinates of the mobile computing device using the GPS circuit.

3. The mobile computing device of claim 2, wherein the plurality of instructions further cause the processor to determine the location of the proposed dig site based on the GPS coordinates.

4. The mobile computing device of claim 1, wherein to obtain location data comprises to receive location data indicative of the current location of the mobile computing device from a remote server, the location data being determined based on an Internet Protocol (IP) address of the mobile computing device.

5. The mobile computing device of claim 1, wherein to obtain location data comprises to receive location data indicative of the current location of the mobile computing device from a remote server, the location data being determined using a cellular triangulation procedure.

6. The mobile computing device of claim 1, wherein the digital map is a second digital map, and
to obtain location data comprises to:
display a first digital map on the display to the user;
receive a selection of an area of the first digital map provided by the user; and
determine location data indicative of the location of the selected area of the first digital map.

7. The mobile computing device of claim 6, wherein to determine location data indicative of the location of the selected area comprises to determine longitude and latitude coordinates of the selected area, and
wherein to display the second digital map comprises to display a second digital map including indicia of the proposed dig site corresponding to the determined longitude and latitude coordinates.

8. The mobile computing device of claim 1, wherein to obtain location data comprises to:
receive a street address provided by the user; and
determine the location data based on the street address.

9. The mobile computing device of claim 1, wherein the plurality of instructions further cause the processor to determine additional dig parameter data that identifies parameters of the digging activity to be performed at the dig site.

10. The mobile computing device of claim 9, wherein the additional dig parameter data comprises at least one of: type of digging activity, depth of proposed digging activity, and duration of digging activity.

11. The mobile computing device of claim 1, wherein the plurality of instructions further cause the processor to determine longitude and latitude coordinates of the dig site based on the location data.

12. The mobile computing device of claim 1, wherein the plurality of instructions further cause the processor to receive a communication from dig site authorization server confirming the dig site location.

13. A method for generating a dig ticket, the method comprising:
determining a current location of a mobile computing device based on global positioning system (GPS) coordinate data generated by a GPS circuit of the mobile computing device;
displaying a digital map on the mobile computing device, the digital map including indicia of a proposed dig site corresponding to the location of the mobile computing device;
verifying the proposed dig site based on a response by a user of the mobile computing device; and
transmitting a dig ticket request to a dig site authorization server over a network in response the dig site being verified.

14. The method of claim 13, further comprising receiving additional dig parameter data from the user, the dig parameter data identifying parameters of the digging activity to be performed at the dig site.

15. The method of claim 14, wherein the additional dig parameter data comprises at least one of: type of digging activity, depth of proposed digging activity, and duration of digging activity.

16. The method of claim 13, further comprising determining the longitude and latitude coordinates of the dig site based on the GPS coordinate data.

17. The method of claim 13, further comprising receiving an e-mail communication from dig site authorization server that confirms the dig site location.

18. A tangible, machine readable medium comprising a plurality of instructions, that in response to being executed, result in a mobile computing device:
determining a current location of the mobile computing device;
displaying a digital map on the mobile computing device, the digital map including indicia of a proposed dig site corresponding to the location of the mobile computing device;
verifying the proposed dig site based on a response by a user of the mobile computing device;
generating a dig ticket request that identifies the proposed dig site in response to the dig site being verified; and
transmitting the dig ticket request to a dig site authorization server over a network.

19. The tangible, machine readable medium of claim 18, wherein determining the current location of the mobile computing device comprises determining the current location based on global positioning system (GPS) coordinate data generated by a GPS circuit of the mobile computing device.

20. The tangible, machine readable medium of claim 18, wherein determining the current location of the mobile computing device comprises determining the current location based on a street address supplied by the user.
